(19) United States
(12) Patent Application Publication
(10) Pub. No.: US 2025/0353562 A1
(43) Pub. Date: Nov. 20, 2025

(54) CARGO PACK FOR ATTACHMENT TO A BICYCLE

(71) Applicant: TAILFIN LIMITED, Bristol (GB)

(72) Inventor: Nicholas BROADBENT, North Somerset (GB)

(21) Appl. No.: 19/210,351

(22) Filed: May 16, 2025

(30) Foreign Application Priority Data
May 18, 2024 (GB) 2407110.2

(51) Int. Cl. B62J 9/26; B62J 6/00; B62J 9/23

(52) U.S. Cl. CPC B62J 9/26; B62J 6/00; B62J 9/23

(57) ABSTRACT

A cargo pack for attachment to a bicycle comprises an outer casing of flexible material which is provided with a reinforcing and mounting structure which includes internal stiffening elements in the form of elongate battens secured adjacent an attachment wall of the outer casing. The battens are each secured to front and rear mounting structures which are disposed on the external surface of the attachment wall and are secured to the stiffening elements by fasteners extending through the material of the attachment wall. The outer casing can be packed and unpacked through a rear portion of the casing, unhindered by the battens.

This invention relates to a cargo pack, and is particularly although not exclusively concerned with a cargo pack for attachment to a bicycle.

Bikepacking is a popular leisure pursuit which often involves multi-day touring on a bicycle, often an off-road bicycle such as a mountain bike. Everything needed for touring is carried on the bicycle or by the rider. There is therefore a need for luggage containers, often referred to as cargo packs, which can be attached to the bicycle and can be loaded with equipment such as clothing, sleeping bags and food.

“Soft” packs, such as collapsible bags, are known for this purpose, but pose particular problems. Because they lack inherent rigidity, they need to be mounted on a cargo rack which supports them from underneath. The necessary support structure thus adds weight to the bicycle as a whole and can cause abrasion if grit or other dirt gets between the bag and the cargo rack. Cargo packs are known which are provided with internal reinforcements to enhance their rigidity, but these reinforcements tend to be constructed and positioned to avoid bulging of the bags when overfilled. Also, known internal reinforcements have a relatively complex structure.

Trunk bags or rack top bags are known for fitting to cargo racks behind the bicycle saddle, and conventionally have top openings. A problem with such top openings is that the saddle can obstruct access to the cargo pack.

According to the present invention there is provided a cargo pack for attachment to a cargo rack on a bicycle, the pack comprising an outer casing of a flexible material provided with an opening for loading the pack, the outer casing having oppositely disposed side walls and an attachment wall extending between the side walls and intended to lie adjacent the cargo rack, the outer casing being provided with elongate stiffening elements disposed on the internal surface of the attachment wall, the cargo pack also comprising front and rear mounting structures which are disposed on the external surface of the attachment wall, each stiffening element being secured to each of the front and rear mounting structures by fasteners extending through the material of the attachment wall.

The stiffening elements may be accommodated in respective elongate pockets extending along the attachment wall. The pack may be elongate, in which case the stiffening elements may extend generally in the lengthwise direction of the pack.

The stiffening elements may be inclined to each other, and may converge in the direction towards the front mounting structure. The stiffening elements may be secured to a common mounting bracket of the front mounting structure. The common mounting bracket may be connected to a fastening device configured for attachment to a seatpost of the bicycle. The common mounting bracket may be connected to the fastening device by a link which is releasably secured to the common mounting bracket and to the fastening device. The link may be connected to the common mounting bracket in a manner which permits rotational adjustment of the link with respect to the common mounting bracket.

The rear mounting structure may comprise a bracket which is secured to the stiffening elements and is provided with aligned spaced-apart mounting formations for engagement with complementary mounting formations on the cargo rack. At least one of the stiffening elements may have an extension projecting beyond the rear mounting structure in the direction away from the front mounting structure and the or each extension may be provided with a fastening location for the mounting of accessories. An accessory in the form of a lamp carrier may be secured to at least one of the stiffening elements at the respective fastening location by means of a fastener extending through the material of the attachment wall.

The outer casing may comprise an elongate container extending in the direction from the front mounting structure to the rear mounting structure, the container having a closable opening at its end away from the front mounting structure.

Another aspect of the present invention provides a bicycle provided with a cargo rack on which is mounted a cargo pack as defined above. The front mounting structure may be secured to a seatpost of the bicycle, and the rear mounting structure may be secured to the cargo rack.

A third aspect of the present invention comprises a kit of parts for assembly as a cargo pack as defined above, comprising:
the outer casing;
at least two of the elongate stiffening elements;
the front and rear mounting structures; and
the fasteners for securing the front and rear mounting structures to the stiffening elements.

For a better understanding of the present invention, and to show more clearly how it may be carried into effect, reference will now be made, by way of example, to the accompanying drawings, in which:

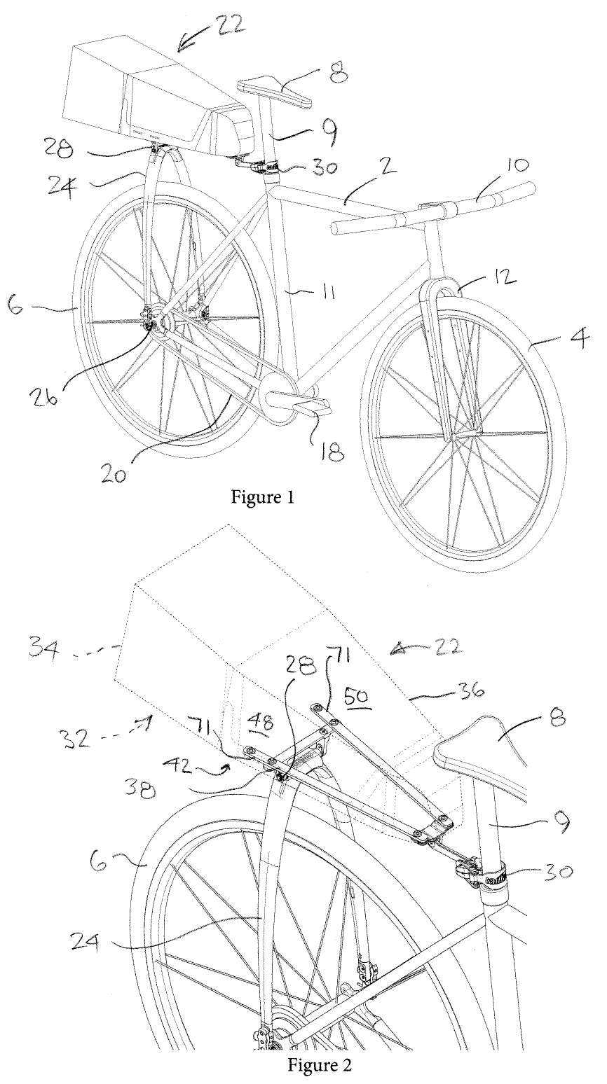

FIG. 1 shows a bicycle having a cargo rack on which a cargo pack is supported;

FIG. 2 is an enlarged view of the rear portion of the bicycle;

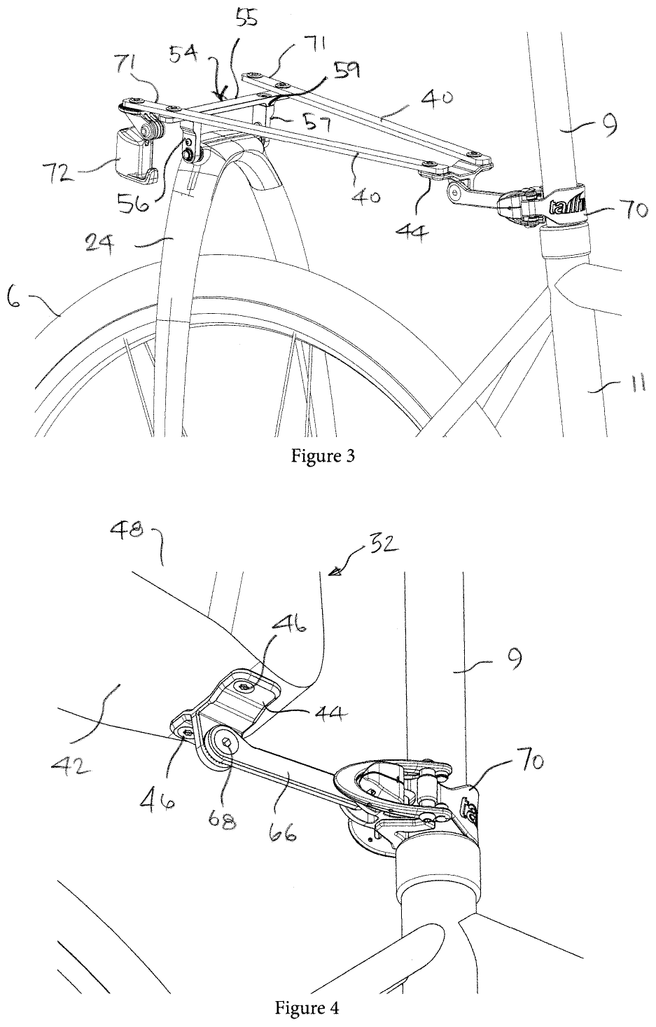

FIG. 3 shows a reinforcing and mounting structure of the cargo pack;

FIG. 4 shows a front mounting structure of the cargo pack;

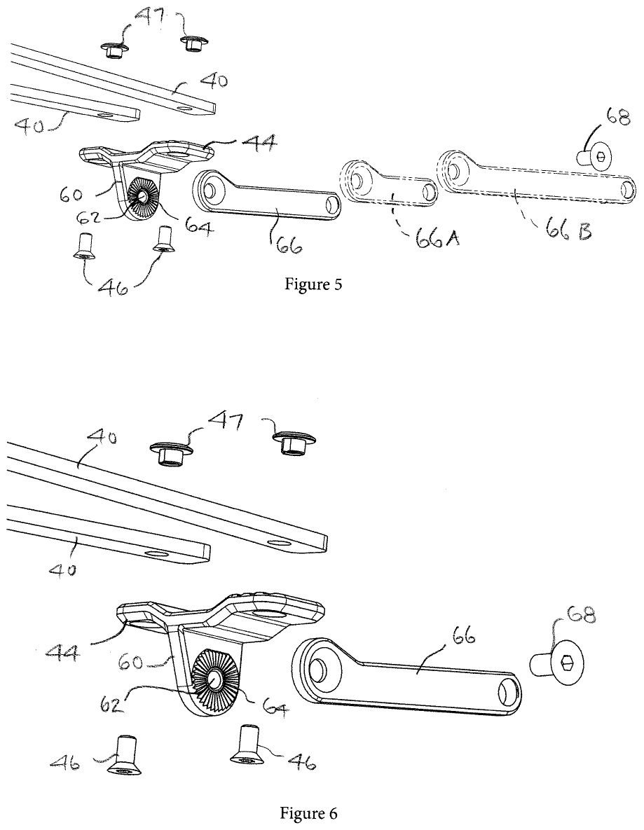

FIG. 5 is an exploded view of the front mounting structure showing alternative components;

FIG. 6 corresponds to FIG. 5 but shows a single one of the alternative components;

FIG. 7 corresponds to FIG. 3 but shows the reinforcing and mounting structure isolated from the bicycle; and

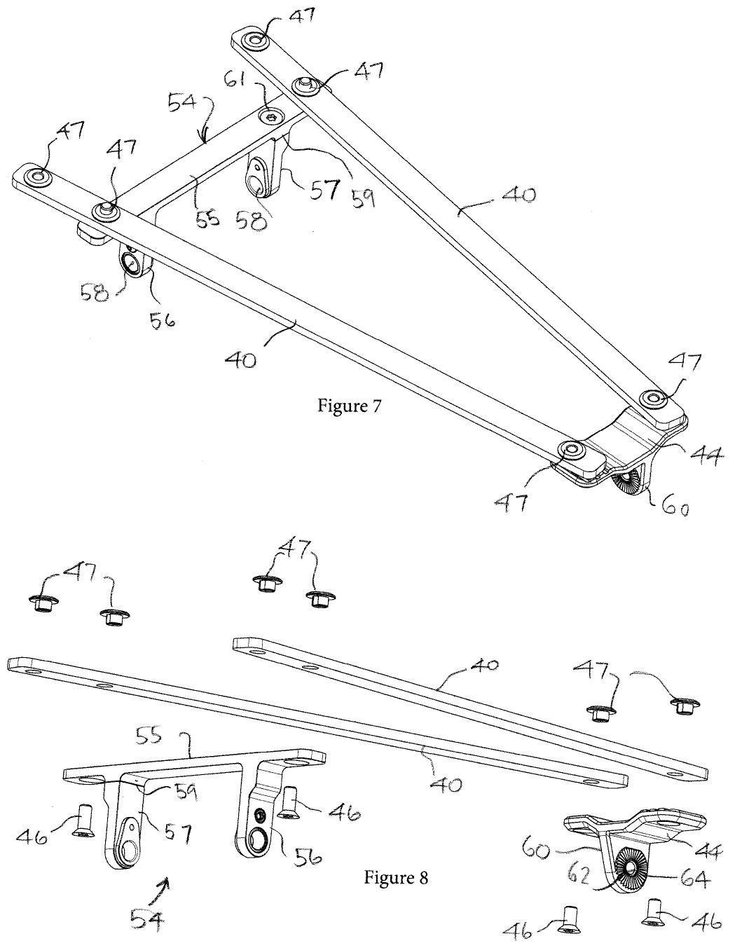

FIG. 8 corresponds to FIG. 7 but is an exploded view of the reinforcing and mounting structure.

Although the bicycle shown in FIG. 1 is of generic form, the present invention may be applied to cargo packs for use with mountain bikes suitable for bikepacking.

The bike of FIG. 1, as is conventional, comprises a frame 2 carrying front and rear wheels 4, 6, a saddle 8 and handlebars 10 for steering the front wheel 4 which is supported by a front fork 12. The saddle 8 is supported on a seatpost 9 which is telescopically fitted into a seat tube 11. Pedals 18 drive the rear wheel 6 through a chain 20.

A cargo pack 22 is supported on the bike by a cargo rack 24 which may be of the form disclosed in GB2542644. The rack 24 comprises a generally inverted U-shaped structure supported on the bicycle by a skewer or through-axle extending through the hub of the rear wheel 6. The cargo pack 22 is secured to the rack 24 by a rear mounting structure 28. At its front end, with respect to the normal direction of travel of the bike, the cargo pack 22 is secured to the seatpost 9 by a front mounting structure 28.

Referring to FIG. 2, the cargo pack 22 comprises a “soft” bag 32 in the form of an outer casing made from a flexible, though preferably waterproof, textile or sheet material such as 420D nylon or other plastics material which is sufficiently stiff to maintain its shape when unstressed, but will flex under load if not supported on its underside. As shown in FIG. 2, the bag 32 has a top wall 50, a bottom wall 42 and opposite side walls 48. The bag 32 has a tapered shape narrowing both in the 10 horizontal direction and in the vertical direction as it approaches the seat 8.

FIG. 2 shows that the bag has a main section 36 and a rear portion 34 which is open at the rear to enable the bag to be packed and unpacked. Closing of the bag may be achieved in a variety of ways, but one solution is for the rear portion 34 to be rolled up towards the main body of the bag 32 and secured in the rolled up configuration by a suitable arrangement of straps and/or buckles.

The main section 36 of the bag 32 is provided with a reinforcing and mounting structure 38 which is shown in greater detail in FIGS. 3 to 8. In FIG. 3, the bag 32 is omitted to show the components of the structure 38. This structure comprises two elongate stiffening elements 40 which are in the form of battens having a generally flat rectangular cross-section. The battens 40 have substantially the same cross-section over their entire length, although they are profiled with rounded corners at their ends. Also, although not shown in the Figures, they may have thickened regions at locations where they are fastened to other components. The battens 40 are substantially rigid, although they may flex slightly under bending loads. They may be made from any suitable material, such as a metallic material, for example an aluminium alloy, or a composite material.

The battens 40 are accommodated within the bag 32. Although not shown in the drawings, the material of the bag 32 may be provided, on the internal surface of its bottom wall 42 (see FIG. 4) with a pocket or sleeve for each batten 40. The lower wall 42 may be regarded as an attachment wall, since it is provided with fittings by which the cargo pack 22 is attached to the rack 24 and the seatpost 9. Each pocket or sleeve may have an elongate form, corresponding to the length of the battens 40, and may be a relatively close fit around the respective batten 40. The pocket or sleeve may be made from the same material as the rest of the bag 32 and may be secured to the internal surface of the attachment wall 42 by, for example, stitching, welding or bonding. Each pocket or sleeve may be open at its end nearer the rear portion 34 of the bag 32 to enable the respective batten 40 to be inserted through the open rear end of the bag 32.

At each of their front ends, each of the battens 40 is fixed to a front mounting bracket 44 of the cargo pack 22 by means of fasteners such as screws 46 and cap nuts 47. The bracket 44 is on the outside of the bag 32, engaging the outer surface of the attachment wall 42. Thus, as shown in FIG. 3, the front ends of the battens 40 are relatively close together. The battens diverge from each other in the rearward direction (with respect to the normal direction of travel of the bike), so matching the tapered shape of the bag 32. Thus, the battens 40 lie relatively close to the respective side walls 48 of the bag.

Towards each of their rear ends, each of the battens 40 is secured by further fasteners such as screws 46 and cap nuts 47 to a rear mounting bracket 54 of the cargo pack 22. As with the front mounting bracket 44, the rear mounting bracket 54 is situated outside the pack 22 and contacts the external surface of the attachment wall 42. Again, the fasteners 46, 47 which connect the rear mounting bracket 54 to the battens 40 extend through the material of the attachment wall 42.

The rear mounting bracket 54 has a cross-bar 55 from which extend a pair of downwardly projecting limbs 56, 57 provided with aligned holes 58. The limb 56 is formed integrally with the cross-bar 55, but the limb 57 is formed separately, and meets the cross-bar 55 at a junction 59, and is secured to the cross-bar 55 by a screw 61. The holes 58 receive mounting pins fitted to the rack 24 so as to hold the rear mounting bracket 54 securely on the rack 24 while permitting rotation of the rear mounting bracket 54 about the common axis of the holes 58. The rear mounting bracket 54 is fitted to the rack 24 by removing the limb 57 enabling the limb 56 to engage the respective mounting pin on the rack. The limb 57, detached from the cross-bar 55, is then fitted over the opposite mounting pin and then secured to the cross-bar 55 using the fastener 61.

The front mounting bracket 44 has a single downwardly projecting limb 60 having a hole 62 surrounded by a serrated ring 64. A link in the form of a strut 66 is connected to the limb 60 by a screw 68 and is provided with serrations corresponding to the serrations 64 so that the strut 66 can be connected to the limb 60 in a range of angular positions which can be fixed by tightening the screw 68.

At the end away from the front mounting bracket 44, the strut 66 is provided with a securing mechanism 70, which may be of known form, for securing the strut 66 to the seatpost 9.

As shown in FIG. 5, the strut 66 can be replaced by any one of a series of struts 66A, 66B in order to vary the distance between the front end of the pack 22 and the seatpost 9. The cargo pack 22 may be supplied with a variety of struts 66, 66A, 66B so that the user can select the strut most appropriate to the user's preference and the configuration of the bicycle to which the cargo pack 22 is to be fitted. Also, the user can adjust the angle at which the strut 66 is fitted to the limb 60 by releasing and re-tightening the screw 68.

With reference to FIG. 3, the battens 40 each have an extension 71 extending to the rear beyond the mounting bracket 54. The extensions are provided with further holes which can be used to fit accessories such as a rear light mount 72 to the pack 22 using fasteners similar to the screws 46 and cap nuts 47. Again, these fasteners extend through the material of the bag 32.

The cargo pack 22 may be supplied to a customer as a kit of parts comprising the bag 32 and the mounting and supporting structure 38 in a disassembled form. Thus, the kit includes the battens 40 and the front and rear mounting brackets 44, 54, as well as the fasteners 46, 47, the screw 68 and the securing mechanism 70. The kit may also include a selection of the struts 66, 66A, 66B. The user then assembles the cargo pack 22 by fitting the battens 40 within the bag 32, for example in sleeves or pockets secured to the attachment wall 42, and attaching the front and rear mounting brackets 44, 54 to the exterior of the bag 32, by means of the screws 46 and cap nuts 47 which pass through the material of the bag 32. The rear mounting bracket 54 is then fitted to the rack 24 as described above by engaging the holes 58 in the limbs 56, 57 with the attachment features provided on the rack 24. The rack 24 is then able to pivot about the axis of the rear wheel 6, and the reinforcing and mounting structure is able to pivot relatively to the rack 24 about the axis of the holes 58. The user then selects the strut 66, or one of the alternative struts 66A, 66B, and fits it loosely to the limb 60 of the front mounting bracket 44, so that the strut is able to pivot about the screw 68. The strut 66 is then secured to the seatpost 9 using the securing mechanism 70 and, once positioned to the satisfaction of the user, the screw 68 can be tightened to fix the position of the strut relative to the front mounting bracket 44 by means of the ring of serrations 64 on the limb 60 and the corresponding serrations on the strut 66.

The bag 32 can then be loaded through the rear end portion 34. It will be appreciated that the low profile battens 40 provide minimal obstruction to articles being placed in the bag 32 while providing a substantially rigid support for the attachment wall 42 to prevent sagging of the bag 32 between the front and rear mounting brackets 44, 54. The battens 40 also serve to provide a rigid link between the rack 24 and the seatpost 9 so stabilising the entire assembly of the rack 24 and the pack 22.

The reinforcing and mounting structure 38 as described above provides the pack 22 with adequate rigidity while enabling easy access to the interior of the pack from the rear. This avoids the problems of packs having a top opening which can be obstructed by the bicycle saddle, without loss of pack rigidity. Also, the simple form of the battens means that the reinforcing and mounting structure can be constructed at low cost, as compared with more complex reinforcing structures used with top loading packs.

1. A cargo pack for attachment to a cargo rack on a bicycle, the pack comprising an outer casing of a flexible material provided with an opening for loading the pack, the outer casing having oppositely disposed side walls and an attachment wall extending between the side walls and intended to lie adjacent the cargo rack, the outer casing being provided with elongate stiffening elements disposed on the internal surface of the attachment wall, the cargo pack also comprising front and rear mounting structures which are disposed on the external surface of the attachment wall, each stiffening element being secured to each of the front and rear mounting structures by fasteners extending through the material of the attachment wall.

2. A cargo pack as claimed in claim 1, in which the stiffening elements are accommodated in respective elongate pockets extending along the attachment wall.

3. A cargo pack as claimed in claim 1, in which the pack is elongate, the stiffening elements extending generally in the lengthwise direction of the pack.

4. A cargo pack as claimed in claim 1, in which the stiffening elements are inclined to each other.

5. A cargo pack as claimed in claim 4, in which the stiffening elements converge in the direction towards the front mounting structure.

6. A cargo pack as claimed in claim 5, in which the stiffening elements are secured to a common mounting bracket of the front mounting structure.

7. A cargo pack as claimed in claim 6, in which the common mounting bracket is connected to a fastening device configured for attachment to a seatpost of the bicycle.

8. A cargo pack as claimed in claim 7, in which the common mounting bracket is connected to the fastening device by a link which is releasably secured to the common mounting bracket and to the fastening device.

9. A cargo pack as claimed in claim 8, in which the link is connected to the common mounting bracket in a manner which permits rotational adjustment of the link with respect to the common mounting bracket.

10. A cargo pack as claimed in claim 5, in which the rear mounting structure comprises a bracket which is secured to the stiffening elements and is provided with aligned spaced-apart mounting formations for engagement with complementary mounting formations on the cargo rack.

11. A cargo pack as claimed in claim 1, in which at least one of the stiffening elements has an extension projecting beyond the rear mounting structure in the direction away from the front mounting structure, the or each extension being provided with a fastening location for the mounting of accessories.

12. A cargo pack as claimed in claim 11, in which an accessory in the form of a lamp carrier is secured to at least one of the stiffening elements at the respective fastening location by means of a fastener extending through the material of the attachment wall.

13. A cargo pack as claimed in claim 1, in which the outer casing comprises an elongate container extending in the direction from the front mounting structure to the rear mounting structure, the container having a closable opening at its end away from the front mounting structure.

14. A bicycle provided with a cargo rack on which is mounted a cargo pack in accordance with claim 1.

15. A bicycle as claimed in claim 14, in which the front mounting structure is secured to a seatpost of the bicycle, and the rear mounting structure is secured to the cargo rack.

16. A kit of parts for assembly as a cargo pack in accordance with claim 1, comprising:
the outer casing;
at least two of the elongate stiffening elements;
the front and rear mounting structures; and
the fasteners for securing the front and rear mounting structures to the stiffening elements.
